(19) United States
(12) Patent Application Publication
(10) Pub. No.: US 2002/0133365 A1
(43) Pub. Date: Sep. 19, 2002

(54) System and method for aggregating reputational information

(76) Inventors: William Grey, Millwood, NY (US); Clifford A. Pickover, Yorktown Heights, NY (US); Paul A. Moskowitz, Yorktown Heights, NY (US); Stephen J. Boies, Mahopac, NY (US)

Correspondence Address: BUCKLEY, MASCHOFF, TALWALKAR, & ALLISON, 5 ELM STREET, NEW CANAAN, CT, 06840, US

(21) Appl. No.: 09/812,175

(22) Filed: Mar. 19, 2001

(51) Int. Cl. G06F 17/60

(52) U.S. Cl. 705/1

(57) ABSTRACT

A system, method, apparatus, and computer program code for aggregating reputation information is provided. In one embodiment, a method of aggregating reputation information includes identifying an entity, identifying a plurality of sources having reputation information about the entity, and generating an aggregated reputation rating for the entity based on information from each of the sources.

### FIELD OF THE INVENTION

The present invention relates to systems and methods for collecting and aggregating reputation information for entities.

### BACKGROUND OF THE INVENTION

Modern communications systems, including telephones, facsimiles, the Internet, and overnight mail delivery have allowed individuals, businesses and other entities to increasingly conduct business with a wide variety of entities around the world. Business is often conducted between entities who have never met, and likely will never meet. Many customers find service providers and merchants by conducting searches over the Internet. Businesses establish relationships with other businesses via electronic marketplaces or exchanges. This expanded marketplace has many advantages to participants, but it can also lead to a number of potential disadvantages.

In particular, due to the relative anonymity of this new expanded marketplace, many customers and businesses can be damaged by poor service, inferior products, or non-responsive relationships that they receive when they interact with other entities in the marketplace. For example, there have been many instances of disreputable merchants selling goods over auction Web sites who do not deliver the goods as advertised. It would be desirable to provide reputation information to allow customers, businesses and other entities with detailed information about third parties so that a more informed decision regarding establishing a relationship may be made.

There are a number of sources of reputation information about entities. For example, some Web sites track customer complaints about users of the Web site. Other Web sites track analyst ratings of companies as well as credit ratings for companies. Unfortunately, all of this information is distributed across different information sources. A consumer wishing to quickly assess the reputation of an entity is unable to do so quickly. Further, even if multiple sources of reputation information can be retrieved, it can be difficult to assess the multiple sources of information because different sources may use different criteria when describing the reputation of an entity.

Accordingly, it would be desirable to aggregate reputation information from a variety of sources. It would also be desirable to generate an aggregated reputation rating for entities based on the aggregated reputation information.

### SUMMARY OF THE INVENTION

Embodiments of the present invention provide a system, method, apparatus, and computer program code for aggregating reputation information about one or more entities. In one embodiment, a method of aggregating reputation information includes identifying an entity, identifying a plurality of sources having reputation information about the entity, and generating an aggregated reputation rating for the entity based on information from each of the sources.

According to one embodiment, reputation information is categorized according to type and the aggregated reputation rating includes an aggregated reputation rating for each type. In one embodiment, the reputation information is validated before generating the aggregated reputation rating. In some embodiments, a fee may be charged to receive an aggregated reputation rating or to provide reputation information.

According to one embodiment, a device for aggregating reputation information is provided including a processor, a communication device, and a storage device storing instructions to generate an aggregated reputation rating for an entity based on reputation information received from each of a plurality of sources.

According to one embodiment, a computer program product in a computer readable medium for aggregating reputation information is provided which includes instructions for identifying an entity, instructions for identifying a plurality of sources having reputation information regarding the entity, and instructions for generating an aggregated reputation rating for the entity based on the reputation information from each of the plurality of sources.

According to another embodiment, a method for aggregating reputation information includes identifying an entity having multiple aliases, where reputation information is available for each of the aliases of the entity. Embodiments of the invention permit the aggregation of reputation information about each of the aliases to generate an aggregateed reputation rating for the entity which takes into account the reputations of the different aliases.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram of a system consistent with the present invention;

FIG. 2 is a block diagram of one embodiment of the controller depicted in FIG. 1;

FIG. 3 is a tabular representation of a portion of an entity database according to an embodiment of the present invention;

FIG. 4 is a tabular representation of a portion of a source database according to an embodiment of the present invention;

FIG. 5 is a tabular representation of a portion of a ratings database according to an embodiment of the present invention;

FIG. 6 is a flow diagram illustrating an exemplary process for identifying and aggregating reputation information according to an embodiment of the present invention; and

FIG. 7 is a flow diagram illustrating an exemplary process for providing reputation information according to an embodiment of the present invention.

### DETAILED DESCRIPTION

Applicants have recognized that there is a need for a system, method, apparatus, and computer program code for aggregating reputation information which overcomes drawbacks of existing systems.

Prior to a detailed description of systems, devices, and processes of the invention, an illustrative example will now be presented to facilitate understanding of embodiments of the present invention.

In this illustrative example, a consumer may wish to purchase an item from a Web-based retailer. However, the consumer may not have a history of dealing with the retailer and may be concerned about the retailer's financial liquidity and ability to deliver the item as well as the retailer's responsiveness to customer complaints. In short, before sending money to the retailer, the customer may wish to have more information about the retailer's reputation. Prior to the invention, the customer may be able to discern bits and pieces of reputation information by contacting the Better Business Bureau, or by contacting other sources of information. Embodiments of the present invention permit the customer to visit a single source for aggregated reputation information about the business. In this example, a central service configured pursuant to the present invention, may aggregate reputation information about the retailer from a variety of sources. This aggregated information is made available to the customer so the customer can, in a single efficient transaction, see reputation information about the retailer. Further, embodiments of the present invention may generate an aggregated reputation rating about the retailer so the customer can have a better insight into the reputation of the retailer. The result is a system which efficiently allows entities such as individual customers to measure and monitor the reputation of other entities so that a more informed decision may be made regarding whether to interact with that other entity.

These and other features will be discussed in further detail below, by first describing the system, individual devices, exemplary databases and processes according to embodiments of the invention.

### System and Devices

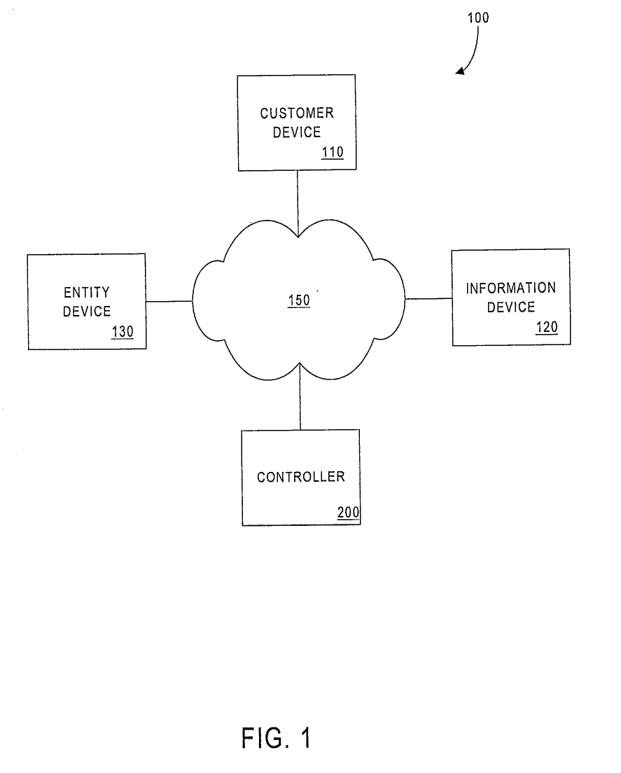

Referring now to FIG. 1, a system 100 for aggregating reputation information according to one embodiment of the present invention is shown. As shown, a customer device 110 is in communication with a controller 200 via a communication network 150. An information device 120 and an entity device 130 are also in communication with controller 200 and with other devices via communication network 150.

Devices 110, 120 and 130 as well as controller 200 may be any devices capable of performing the various functions described herein. For example, devices 110, 120, 130 and/or 200 may be, for example: a Personal Computer (PC), a portable computing device such as a Personal Digital Assistant (PDA), a wired or wireless telephone, a one-way or two-way pager, a kiosk (e.g., consumers may retrieve aggregated reputation information from a customer device 110 configured at a kiosk located at a library), an interactive television device, or any other appropriate storage and/or communication device.

For the purposes of simplicity in describing system 100, only a single one of each of the devices 110, 120, 130 and 200 are shown. However, as will become apparent, any number of the devices 110, 120, 130 and 200 may be used. In one embodiment, for example, a single controller 200 serves to aggregate reputation information for a large number of entities, which information is received from a large number of information devices 120. A large number of customers operating customer devices 110 may access and use this aggregated reputation information.

As used herein, communication network 150 may employ any of a number of different types and modes of communication, and may be for example, a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology. More direct forms of communication between devices may also be used, for example, entities providing reputation information about other entities may provide the information via mail, telephone, facsimile, etc. Other devices may communicate in this manner as well.

In one embodiment of the present invention (which will be used as an illustrative embodiment to describe features of embodiments of the invention throughout this specification) devices 110, 120 and 130 communicate with a remote, Web-based controller 200 (e.g., configured as a server) via the Internet. Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system.

Customer device 110, according to one embodiment of the invention, may be operated by or on behalf of an individual consumer wishing to receive aggregated reputation information about an entity with which the individual consumer is considering doing business with, for example. Customer device 110 may be operated by any of a number of different types of users who desire to receive aggregated reputation information about entities including, for example: consumers, businesses, schools, service providers, employers, etc.

Information device 120, according to one embodiment of the present invention, may be operated by or on behalf of entities which have reputation information about other entities. For example, information device 120 may be operated by: an entity operating a Web site; an entity operating an electronic marketplace; a credit bureau; a credit rating service; a consumer watchdog group (such as Consumer Reports, or the Better Business Bureau); state or governmental agencies (such as a State Attorney General's office); etc.

Entity device 130, according to one embodiment of the present invention, may be operated by or on behalf of entities for which reputation information is collected by entities operating information devices 120 and for which aggregated reputation information is desired. According to embodiments of the invention, aggregated reputation information may be generated for entities which do not operate an entity device 130, although in some embodiments, entities will operate such a device. Entities for which aggregated reputation information is generated may be any of a number of different types of entities, including, for example: individuals; corporations; partnerships; law firms; retail, wholesale, or other commercial businesses; clubs; non profit organizations; geographic units; pets; animals; individual services or products; etc.

Note that the devices shown in FIG. 1 need not be in constant communication. For example, devices 110, 120 and 130 may only communicate with controller 200 via the Internet when appropriate (e.g., customer device 110 may only interact with controller 200 when a customer directs a browser on his PC to a Web site operated by an entity operating controller 200).

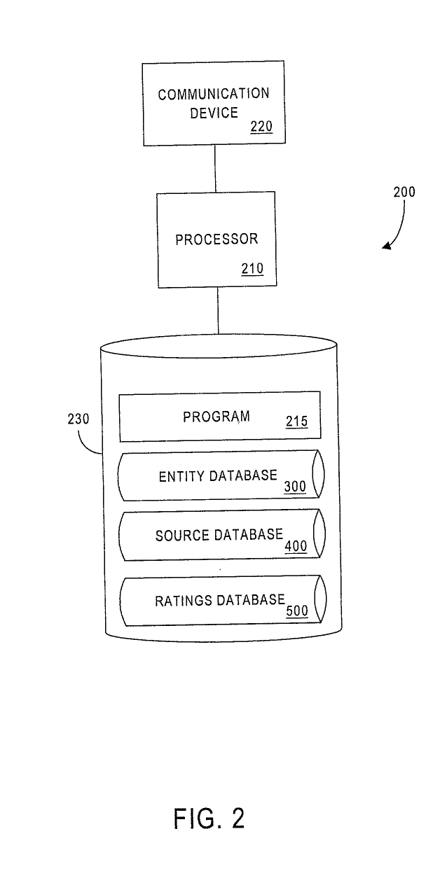

One embodiment of controller 200 will now be described by referring to FIG. 2. In one embodiment, controller 200 is operated by or on behalf of an entity configured to aggregate reputation information about other entities and which generates aggregated reputation ratings for end users of that information. In one embodiment, controller 200 is a Web-based server in communication with one or more customer devices 110, information devices 120 and entity devices 130 via a network such as the Internet. Those skilled in the art will recognize, upon reading this disclosure, that controller 200 may be implemented as a system controller, a dedicated hardware circuit, an appropriately programmed general purpose computer, or any other equivalent electronic, mechanical or electro-mechanical device capable of providing the functionality described herein.

Controller 200 comprises a processor 210, such as one or more Intel® Pentium® processors. Processor 210 is coupled to a communication port 220 through which processor 210 communicates with other devices, such as, for example, one or more devices 110, 120 and 130. Communication port 220 may include hardware and software facilitating communication with other devices using wired or wireless techniques, or a combination of different techniques. For example, communication port 220 may be one or more of: a network adapter, a modem, a router, a Bluetooth chip, etc.

Processor 210 is also in communication with a data storage device 230. Data storage device 230 comprises an appropriate combination of magnetic, optical and/or semiconductor memory, and may include, for example, Random Access Memory (RAM), Read-Only Memory (ROM), a compact disc and/or a hard disk. Processor 210 and data storage device 230 may each be, for example: (i) located entirely within a single computer or other computing device; or (ii) connected to each other by a remote communication medium, such as a serial port cable, telephone line or radio frequency transceiver. In one embodiment, controller 200 may comprise one or more computers that are connected to a remote server computer for maintaining databases.

Data storage device 230 stores a program 215 for controlling processor 210. Processor 210 performs instructions of program 215, and thereby operates in accordance with the present invention, and particularly in accordance with the methods described in detail herein. Program 215 may be stored in a compressed, uncompiled and/or encrypted format. Program 215 furthermore includes program elements that may be necessary, such as an operating system, a database management system and “device drivers” for allowing processor 210 to interface with computer peripheral devices. Appropriate program elements are known to those skilled in the art, and need not be described in detail herein.

According to an embodiment of the present invention, the instructions of program 215 may be read into a main memory from another computer-readable medium, such from a ROM to RAM. Execution of sequences of the instructions in program 215 causes processor 210 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Data storage device 230 also stores one or more databases including an entity database 300, a source database 400, and a ratings database 500. These databases are described in detail below and depicted with exemplary entries in the accompanying figures. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

### Databases

1. Entity Database

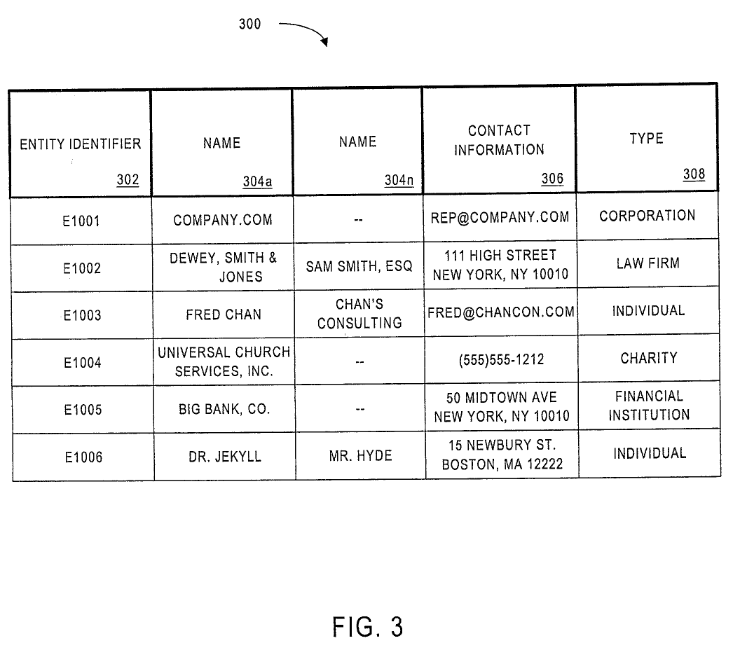

Referring now to FIG. 3, a table represents entity database 300 that may be stored at controller 200 according to an embodiment of the present invention. In some embodiments, all or portions of entity database 300 may be stored among different ones of devices 110, 120, or 130, however, in a preferred embodiment, the information is stored at controller 200.

The table includes entries identifying different entities for which reputation information has been received. The table also defines fields 302, 304, 306, and 308 for each of the entries. The fields specify: an entity identifier 302, a name(s) 304, contact information 306, and a type 308. The information in entity database 300 may be created and updated, for example, based on information received from individual information devices 120. The information may also be received directly from the entities themselves, for example, via a registration process conducted between entity device 130 and controller 200 where the entity provides detailed information about itself to facilitate the aggregation of rating information about itself. The information may also be provided by individual customers operating customer devices 110.

Entity identifier 302 may be, for example, an alphanumeric code associated with a particular entity for which reputation information is aggregated using embodiments of the present invention. Entity identifier 302 may be generated by, for example, individual entities operating entity devices 130 or may be assigned by controller 200 to track different entities for rating. Alternatively, or in addition, entity identifier 302 may also be provided by entities operating information device 120 or by customers operating customer device 110.

Name(s) 304 may be information used to identify a particular entity identified by entity identifier 302. This information may be, for example, a legal corporate name of the business, a pseudonym for the business, the name of an individual, etc. Because some entities operate using more than one name or alias, embodiments of the present invention attempt to track these multiple names in entity database 300.

Contact information 306 may also be included for each entity identified by entity identifier 302. Contact information 306 may include information allowing an entity operating controller 200, customer device 110, information device 120, or other entity devices 130 to contact the entity identified by entity identifier 302. Example information included in contact information 306 may include: a corporate address, an electronic mail address, a telephone number, or the like.

Type 308 may be information identifying the particular type of entity identified by entity identifier 302. According to embodiments of the invention, this permits detailed aggregation of reputation information across multiple entities within a particular type to generate an industry comparison rating. Examples of types of entities which may be included in database 300 are: corporation, law firm, individual, charity, non-profit, financial institution, etc.

2. Source Database

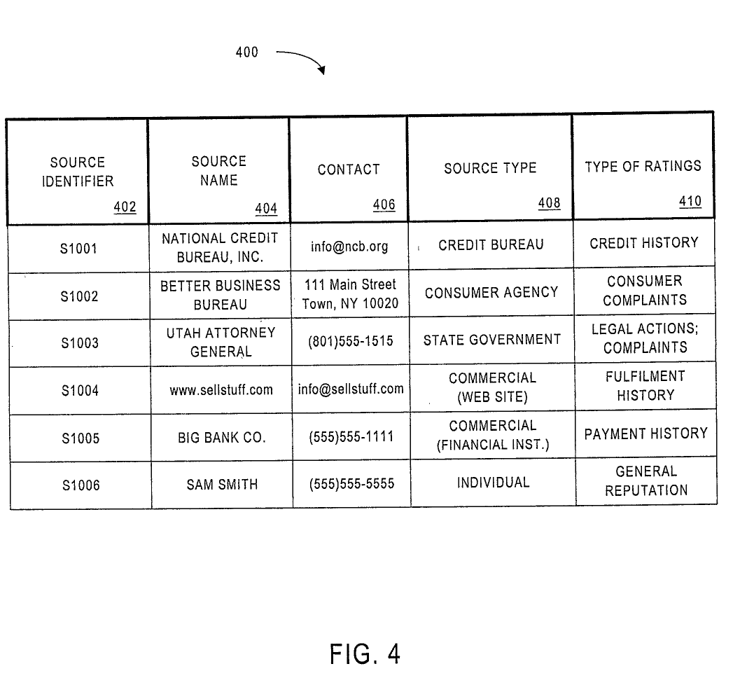

Referring to FIG. 4, a table represents a source database 400 that may be stored at controller 200 according to an embodiment of the present invention. In some embodiments, all or portions of source database 400 may be stored among different ones of devices 110, 120, or 130, however, in a preferred embodiment, the information is stored at controller 200.

The table includes entries identifying sources of reputation information that are received from information providers operating, e.g., information devices 130. The table also defines fields 402, 404, 406, 408 and 410 for each of the entries. The fields specify: a source identifier 402, a source name 404, a contact 406, a source type 408, and a type of ratings 410. The data in source database 400 may be created and updated, for example, based on information received from entities which generate reputation ratings for entities. For example, a consumer watchdog Web site which tracks consumer complaints about different businesses may provide this information to controller 200. Alternatively, controller 200 may seek out this information and copy the reputation information from the Web site, storing the retrieved information in database 400. As another example, a consumer to consumer auction Web site may encourage users to provide reputation ratings for individual consumers who sell goods using the site. Embodiments of the present invention may retrieve information from the Web site about those individual consumers and store the information in controller 200. The information about the source from which the reputation information was retrieved may be stored in database 400 (the actual reputation information may be stored in database 500 discussed further below, while information identifying the individual consumers may be stored in database 300 discussed above).

Source identifier 402 may be, for example, an alphanumeric code associated with a particular source of reputation information. Source identifier 402 may be generated by, for example, the individual sources operating information devices 120 or may be assigned by controller 200 to track each of the different sources who provide reputation information.

Source name 404 may be information used to identify a particular source identified by source identifier 402. This information may be, for example, a legal corporate name of the business, a pseudonym for the business, the name of an individual, etc. Because some sources may operate using more than one name or alias, embodiments of the present invention may also attempt to track these multiple names in source database 400.

Contact information 406 may also be included for each source identified by source identifier 402. Contact information 406 may include information allowing an entity operating controller 200, customer device 110, and/or entity devices 130 to contact the source of information identified by source identifier 402. Example information included in contact information 406 may include: a corporate address, an electronic mail address, a telephone number, or the like.

Source type 408 may be information identifying the particular type of source that source 402 is. For example, reputation information may be provided by the following types of sources: an entity operating a Web site; an entity operating an electronic marketplace; a credit bureau; a credit rating service; a consumer watchdog group (such as Consumer Reports, or the Better Business Bureau); state or governmental agencies (such as a State Attorney General's office); etc. More specific types may also be provided, such as: commercial (financial institution); commercial (retailer); commercial (wholesaler); commercial (web site); State Government; individual, etc. Tracking particular types of sources of reputation information permits embodiments of the present invention to aggregate reputation information by type of source.

Type of ratings 410 may include information that identifies the types of ratings that are provided by the source identified by source identifier 402. For example, sources may provide a number of different types of ratings, such as: credit history; consumer complaints; legal actions (complaints); fulfillment history; payment history; general reputation; etc. By tracking particular types of ratings, embodiments of the present invention permit the aggregation of reputation information by type of ratings (e.g., an aggregated rating for an entity's credit history from different sources may be provided).

Some or all of the information from source database 400 may be shared with or stored at user device 200 and/or vendor device 300.

3. Ratings Database

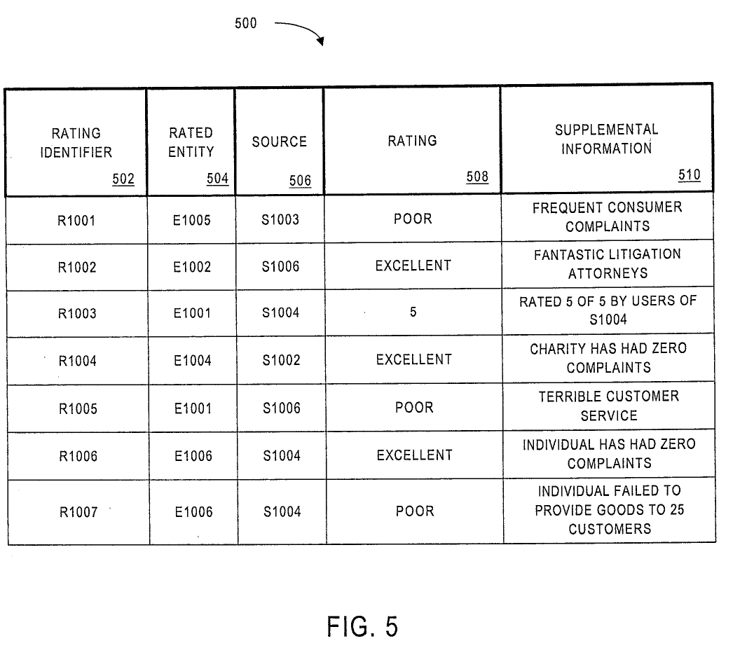

Referring now to FIG. 5, a table represents a ratings database 500 that may be stored at controller 200 according to an embodiment of the present invention. In some embodiments, all or portions of ratings database 500 may be stored among different ones of devices 110, 120, or 130, however, in a preferred embodiment, the information is stored at controller 200.

The table includes entries identifying ratings for entities for which reputation information has been received from information providers operating, e.g., information devices 130. The table also defines fields 502, 504, 506, 508 and 510 for each of the entries. The fields specify: a rating identifier 502, a rated entity 504, a source 506, a rating 508, and supplemental information 510. The data in ratings database 500 may be created and updated, for example, based on information received from entities which generate reputation ratings for entities. For example, a consumer watchdog Web site which tracks consumer complaints about different businesses may provide this information to controller 200. Alternatively, controller 200 may seek out this information and copy the reputation information from the Web site, storing the retrieved information in database 500. As another example, a consumer to consumer auction Web site may encourage users to provide reputation ratings for individual consumers who sell goods using the site. Embodiments of the present invention may retrieve information from the Web site about those individual consumers and store the reputation information in database 500. The information about the source from which the reputation information was retrieved may be stored in database 400 (described above), while information identifying the individual consumers may be stored in database 300 (discussed above).

Rating identifier 502 may be, for example, an alphanumeric code associated with a particular reputation rating. Rating identifier 502 may be an identifier generated by, for example, the individual sources operating information devices 120 or may be assigned by controller 200 to track each of the different ratings received.

Rated entity 504 may be based on or equivalent to the entity identifier 302 stored in entity database 300 (FIG. 3), and is used to particularly associate a rating with a specific entity. According to one embodiment of the present invention, a number of different sources and ratings are provided for each entity. Source 506 may be based on or equivalent to the source identifier 402 stored in source database 400 (FIG. 4), and is used to particularly associate a rating of an entity with the source of the rating.

Rating 508 includes information identifying a particular rating given by source 506 for rated entity 504. Different sources 506 may utilize different rating schemes. For example, a Web site, using information received from participants in auctions, may produce ratings for frequent sellers in auctions on a scale from one to five (with five being excellent and one being terrible). A government watchdog agency may rate businesses based on the number of consumer complaints that have been lodged against the business, with a “Poor” rating indicating that there have been many complaints, while an “Excellent” rating indicates that there have been no complaints lodged. Any of a number of different types of ratings may be provided, tracked, and aggregated using embodiments of the present invention.

Supplemental information 510 may include additional information provided by source 506 which may be used to characterize or further understand rating 508. For example, supplemental information 510 may include details about why a particular rating was given (e.g., the entity had “Frequent Customer Complaints”), details regarding the basis for a particular type of rating (e.g., users of a Web site voted a particular entity as “Excellent”), etc. This supplemental information 510 may be used, in some embodiments, to assist in the aggregation of different ratings for a rated entity 504.

Some or all of the information from ratings database 500 may be shared with or stored at user device 200 and/or vendor device 300.

### Process Description

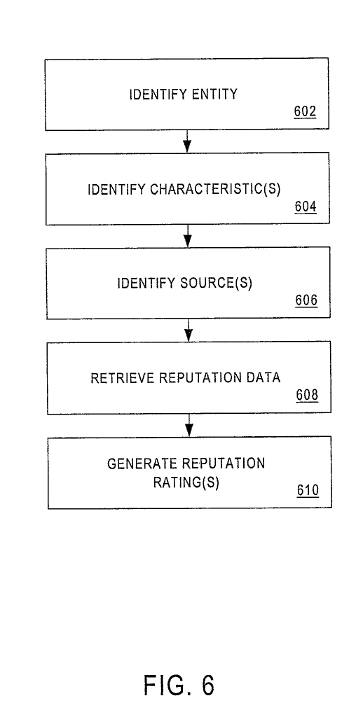

Reference is now made to FIG. 6, where a flow chart 600 is shown which represents the operation of an embodiment of the present invention. The particular arrangement of elements in the flow chart of FIG. 6, is not meant to imply a fixed order to the steps; embodiments of the present invention can be practiced in any order that is practicable. After a description of the flow chart 600, several illustrative examples will be presented to facilitate understanding of embodiments of the present invention.

Flow chart 600 depicts a process for generating reputation rating(s) which may be performed using system 100 of FIG. 1. Processing begins at 602 when controller 200 identifies an entity for which a rating is desired. For example, controller 200 may receive a request from a customer operating a customer device 110 for a reputation rating on the entity, or controller 200 may receive updated information about an entity from information device 120. The entity may be identified at 602 by receiving a name of the entity and comparing the name with stored names in entity database 300. If the entity is not already identified in database 300, a new record identifying the entity may be added at this time.

Once the entity has been identified, processing continues to 604 where characteristic(s) of the entity are identified. This may involve, for example, identifying a type of the entity (e.g., item 308 of FIG. 3) so that the entity may be properly classified. Once identified, the information may be stored in entity database 300.

Processing continues at 606 where source(s) 402 of reputation information are identified. This may be performed, for example, by conducting searches over the Internet for sources of reputation information about the entity (e.g., looking for Web-sites rating the entity, etc.). This may also include searching known databases of reputation information for information about this particular entity (e.g., searching Standard & Poors or Dunn & Bradstreet for financial rating information, etc.). The nature and scope of identification of types of sources may depend upon the type of entity for which data is being sought. For example, a publicly-traded company may have many more sources of reputation information than an individual.

Once source(s) are identified, processing continues at 608 where the system functions to retrieve reputation data from each of the identified source(s). This may simply involve retrieving and copying data from Web sites or may require more complex interaction with source(s) (e.g., some sources may require the payment of money or a subscription to retrieve the data). In some embodiments, data regarding the nature of the information retrieved from each source may also be retrieved (e.g., the basis of the sources rating system, etc.).

Once reputation data has been retrieved for the entity, processing continues at 610 where the system generates reputation rating(s) for the entity. This reputation rating may be generated in any of a number of ways. For example, the reputation rating may be a weighted average of all of the individual reputation ratings received from the various sources. The reputation rating may also be broken down by the type of source (e.g., a rating aggregating all credit bureau ratings may be provided). Other techniques may also be used to generate the reputation rating. For example, a simple combination of all ratings from all sources may be provided, rules of thumb and/or heuristics may be used, scoring metrics may be used, etc. Those skilled in the art will recognize that a wide variety of techniques may be used to manipulate multiple ratings to provide one aggregated rating. This aggregated rating may be updated on a regular basis or every time new reputation data comes in for the entity.

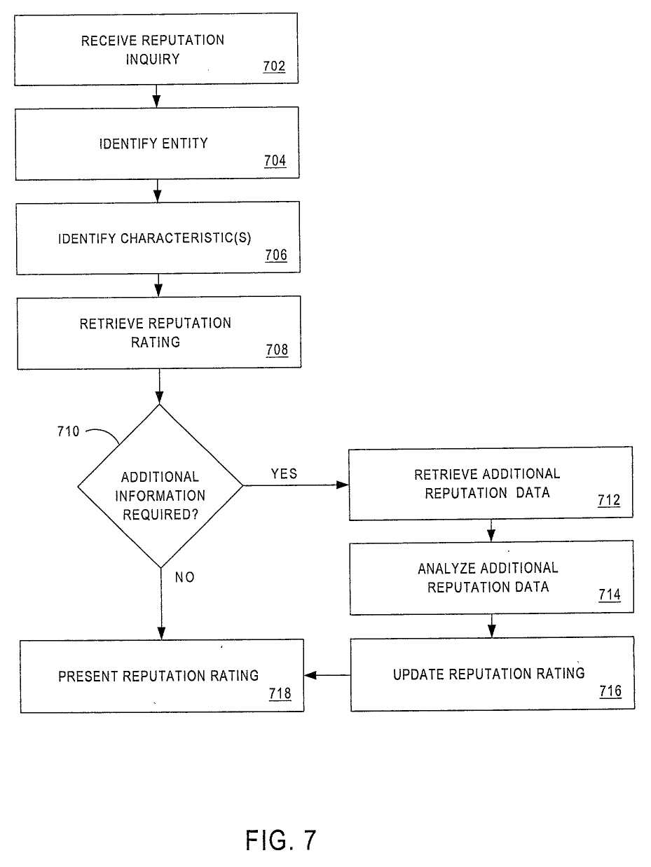

Referring now to FIG. 7, a further process 700 is depicted for generating reputation ratings. In this embodiment, processing begins at 702 where controller 200 receives a reputation inquiry. For example, a customer operating customer device 110 may submit a reputation inquiry seeking reputation information about an entity. In some embodiments, this inquiry may require the payment of a fee.

At 704, controller 200 functions to identify the entity for which the inquiry is presented. This may be done by comparing an entity name provided by the customer with entries in entity database 300. Processing continues at 706 where controller 200 identifies characteristic(s) of the entity for which reputation is requested. For example, if the customer is seeking reputation information about a company with several different divisions (e.g., a financial services division and a retail division), the customer may wish to specify that he is interested in the financial characteristics of the entity.

Processing continues at 708 where controller 200 retrieves a reputation rating about the entity. In some situations, this reputation rating may be old or may not be based on sufficient information to be statistically relevant. Processing at 710 determines whether additional information is required. If so, processing continues at 712 where additional reputation data is retrieved. This additional data may be retrieved from one or more sources (e.g., as described in conjunction with FIG. 6, above). Processing continues at 714 where the additional reputation data is analyzed. At 716 the reputation rating for the entity is updated and the reputation rating is then presented to the party requesting the rating.

If processing at 710 determines that no additional information is required, processing may proceed directly to 718 where the reputation rating is presented to the party requesting the rating.

Although the present invention has been described with respect to a preferred embodiment thereof, those skilled in the art will note that various substitutions may be made to those embodiments described herein without departing from the spirit and scope of the present invention. For example, although payment by a customer has been described, in other embodiments, individual entities or sources of information may also pay the entity operating controller 200 for the service it provides. Further, in some embodiments, a further step of verifying the accuracy or veracity of rating data is provided. In some embodiments, only particular customers may retrieve data using embodiments of the present invention (e.g., only customers who subscribe may use the system).

What is claimed is:

1. A method of aggregating reputation information, comprising:
identifying an entity;
identifying a plurality of sources having reputation information regarding said entity; and
generating an aggregated reputation rating for said entity based on said reputation information from each of said plurality of sources.

2. The method of claim 1, wherein said entity is at least one of: an individual; a corporation; a partnership; a retailer; a financial institution; a law firm; a club; a non-profit group; a charity; a geographic unit; an animal; a product; sole proprietorship, a limited liability company, and a service.

3. The method of claim 1, wherein said plurality of sources includes at least one of: an individual consumer; a web site; an electronic marketplace; a credit bureau; a credit rating service; a consumer watchdog group; and another entity.

4. The method of claim 1, wherein said entity is identified by one or more entity names.

5. The method of claim 1, wherein said reputation information includes at least one of: web site reputation data; payment history data; fulfillment history data; commitment history data; third party recommendation data; and credit data.

6. The method of claim 1, further comprising:
categorizing said reputation information by type, wherein said generating an aggregated reputation rating further comprises generating an aggregated reputation rating based on each type of said reputation information.

7. The method of claim 6, wherein said type of reputation information includes at least one of: employee attributes; professional services attributes; customer attributes; client attributes; political attributes; religious attributes; company attributes; product attributes; integrity attributes; reliability attributes; and service attributes.

8. The method of claim 1, further comprising:
validating the accuracy of said reputation information prior to generating said aggregate reputation rating.

9. The method of claim 1, further comprising:
updating said aggregated reputation rating upon receipt of further reputation information.

10. The method of claim 1, further comprising:
identifying at least two entities as a group; and
generating a group aggregated reputation rating for said group based on reputation information from each of said plurality of sources.

11. The method of claim 1, where in said aggregated reputation rating includes at least one of: a summary report; a graphical display; an icon; an alphanumeric rating; and a recommendation.

12. The method of claim 1, further comprising receiving payment for said aggregated reputation rating, wherein said payment is made by at least one of: said entity; said sources; and a recipient of said aggregated reputation rating.

13. The method of claim 1, further comprising making payment for said aggregated reputation rating, wherein said payment is made to at least one of: said entity and said sources.

14. The method of claim 1, further comprising:
providing said aggregated reputation rating to a user.

15. The method of claim 14, wherein said providing further comprises:
receiving a fee from said user.

16. The method of claim 1, further comprising:
providing said aggregated reputation rating to an authorized recipient of said rating.

17. The method of claim 16, wherein said recipient is authorized based on criteria established by said entity.

18. The method of claim 1, wherein said aggregated reputation rating is a weighted average of a said reputation information.

19. The method of claim 1, wherein said aggregated reputation rating is generated by applying one or more scoring metrics to said reputation information.

20. A device for aggregating reputation information about an entity, comprising:
a processor;
a communication device, coupled to said processor, receiving reputation information about said entity from a plurality of sources; and
a storage device in communication with said processor and storing instructions adapted to be executed by said processor to:
generate an aggregated reputation rating for said entity based on said reputation information received from each of said plurality of sources.

21. The device of claim 20, further comprising instructions adapted to be executed by said processor to:
categorize said reputation information by type; and
generate said aggregated reputation rating for each of said types of reputation information.

22. The device of claim 20, further comprising instructions adapted to be executed by said processor to:
forward said aggregated reputation rating to an end user.

23. The device of claim 20, further comprising instructions adapted to be executed by said processor to:
receive further reputation information for said entity; and
update said aggregated reputation rating for said entity.

24. A computer program product in a computer readable medium for aggregating reputation information, comprising:
first instructions for identifying an entity;
second instructions for identifying a plurality of sources having reputation information regarding said entity; and
third instructions for generating an aggregated reputation rating for said entity based on said reputation information from each of said plurality of sources.

25. A method of aggregating reputation information, comprising:
identifying an entity having at least a first and a second alias;
identifying at least a first source having reputation information regarding a reputation of said at least first alias of said entity;
identifying at least a second source having reputation information regarding a reputation of said at least second alias of said entity; and
generating an aggregated reputation rating for said entity based on said reputation information from said at least first and second sources.
